(19) United States
(12) Patent Application Publication
(10) Pub. No.: US 2009/0049298 A1
(43) Pub. Date: Feb. 19, 2009

(54) System for remote electronic notarization and signatory verification and authentication/ interface/ interlinked with an advanced steganographic cryptographic protocol

(76) Inventors: Jesse Andrew Hatter, Corona, CA (US); Brenda Faye Hatter, Corona, CA (US); Audrella Marie Jackson, Corona, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/069,676

(22) Filed: Feb. 12, 2008

Related U.S. Application Data
(60) Provisional application No. 60/964,873, filed on Aug. 16, 2007.

(51) Int. Cl. H04L 9/06

(52) U.S. Cl. 713/176

(57) ABSTRACT

A method for remote electronic verification and authentication and screening of potential signatories for remote electronic notary transactions via remote pc encrypted platform to a broadband digitally or WIFI cellular/PDA device or portable pc device. The system implements the following electronic components, but not limited to, electronic signature device, digital certificates, electronic document, electronic biometric devices, electronic audio/visual software/hardware, and electronic payment systems and devices, all electronically synchronized to afford capable notary publics in executing remote electronic notary transactions via a satellite kiosk network or on-line virtual kiosk application.

### CROSS REFERENCE TO RELATED APPLICATION

This application claims the benefit of Utility Ser. No. 11/880,618 filed Jul. 23, 2007 and Provisional application 60/964,873 filed on Aug. 16, 2007 the entire contents of which is hereby expressly incorporated by reference herein.

### FIELD OF THE INVENTION

This invention relates to systemization of a remote notary. More particularly, the present application relates to a software platform that augments electronic components in an network environment of servers, satellite kiosk and on-line virtual kiosk application, COM-linked to telecommunication devices in providing screening/verification, signature authentication, record biometric data, record live audio/video streams of potential signatories as well as provide for electronic payment device and system for the processing of remote electronic notary public compensation.

The highlight of this invention is the functions of the system, to steganographically, embed the electronic signature with cryptographic protocol information that in fact acts as an “Electronic DNA” for the entire remote electronic notary transaction. Signatories via remote electronic signature devices or pc appended electronic signatures per COM-link to live notaries, will have their signatures steganographically embedded with cryptographic protocol information within the font lines of their electronic signature unique to the particular remote electronic notary transaction. Enhanced resolution of the electronic signature will reveal this cryptographic protocol for future Signatory and notary electronic signature authentication and verification.

This steganographic cryptographic protocol information is aligned with a conversion data base, providing not only the unique authentication and verification of the electronic signatures of the notary and Signatory, yet creating a basis for electronic forgery prevention and through date/time stamp technology systematized to this art, prohibits unauthorized electronic implementation of these signatures within the scope of this art.

### BACKGROUND OF THE INVENTION

The primary function of this system invention is to interface/interlink human legal activity with electronic and biometric computer components to execute remote electronic notarization via satellite network kiosk or on-line web application. In the Bible there are two scriptures that distinctly describe the manner in which the background of this invention will be explained. According to the King James Version of the Bible, in the Book entitle the First epistle of John or more colloquially known as I John, chapter five versus seven and eight, it reads, “For there are three that bear record in heaven, the Father, the Word, and the Holy Ghost: and these three are one.”; and “And there are three that bear witness in earth, the Spirit, and the water, and the blood: and these three agree in one.” These two scriptures highlight a central theme that causes cooperation and agreement; bringing together, both record and witness into one. Therefore the aforementioned qualifies as a pure approach to a most peculiar form of collaboration known in mathematical game theory circles as the Nash Equilibrium (named after John Forbes Nash, who proposed it), which in fact is a solution concept of game theory wherein it involves two or more players, in which no player has anything to gain by changing only his or her own strategy unilaterally. If each player has chosen a strategy and no player can benefit by changing his or her strategy while the other players keep their strategy unchanged, then the current set of strategy choices and the corresponding payoffs constitute a Nash Equilibrium. Stated simply, you and I are in Nash Equilibrium if I am making the best decision I can, taking into account your decision, and you are making the best decision you can, taking into account my decision. Likewise, many players are in Nash Equilibrium if each one is making the best decision (s)he can, taking into account the decisions of the others.

The following information will background the current positions of the governments that would welcome this unique approach that economic alchemist would soon embrace in addressing an emerging economic globalization movement. The governments of the world, more specifically the industrialized nations, all suggest that sharing the wealth is the key to peace. Men of peace assume that the basis of most war is due to poverty and oppression, lack of opportunity, and rampant greed. However along with the wealth comes the responsibility and proper administration of it, thus the need for trade agreements unilaterally. With this movement for world peace through economic globalization, it is important to note and understand the framework whereby this goal is being achieved.

As the United States is a major player and is participating in the commandeering of this transition, one of its unique economic approaches is brought to bear on the matter of international trade agreements and economic globalization in particular to E-commerce. It is at this point within the background explanation of this invention that we begin to experience the Nash Equilibrium. As entities worldwide begin to enhance their infrastructures to accommodate a variety of dynamics occurring within the sector of E-Commerce, legal framework such as the Electronic Signature in Global and National Commerce Act (E-sign) and the Uniform and Electronic Transaction Act (U.E.T.A.), Government Paper Elimination Act (GPEA), PDD-63 President Management Act, 1996, 2001, 2005, UNICITRAL Model Law for E-Commerce, E-Signature, and E-Contracting, all allowing for innovative electronic approaches approved for legal adoption by Local, State, National, and International Legislatures design to enhance E-commerce integrity. In the State of Utah, legislators have authored Rule 154-10-502 providing for Notary Public Acknowledgement by Electronic Communication mandating that, “Any person(s) executing a notarization using their digital signature and electronic communication requires live audio and visual communication, demonstrating compliance with U.C.A. Section 46-1-2(1) and 46-1-2(11)(c). The following minimal specifications must be met and require:

1. Constant video frame rate of 15 frames per second or more.

2. Minimum video resolution of 320×240 picture elements (PIXELS).

3. Complies with desktop conferencing industry standard H.323 for communication via data networks and the Internet.

4. Full-duplex audio (this means audio in both directions at the same time).

This Rule alone is tantamount to the substance of the aforementioned in that not only does it rubber stamp Remote Electronic Notarization, it offers specifications for implementation, framing its legal parameters.

The authors of these acts, based on the tenor of their words, appear to have anticipated increased E-economic activity via the world wide web as global trade agreements such as (GATT) Global Alliance Trade Tariffs, (NAFTA) North American Free Trade Agreement, (CAFTA) Central American Free Trade Agreement, (MEFTA) Middle East Free Trade Agreement, (FTAA) Free Trade Agreements of the Americas, (SACU) South African Customs Union, etc. . . . begin to have their effect in the E-commerce environment. In fact, it is part of the function of the United Nations and World Trade Organization to insure that civil stability will have its foundation as E-commerce interfaces “Nash” equilibrium principles. This form of game theory (Nash Equilibrium) is the observed hope that men of peace appear to be seeking in solving the aforementioned causes of war. However this game theory can be applied in other areas such as new and innovative approaches to Remote Electronic Notarization. Subsequently, continuing within the scope of the following demonstration of the Nash Equilibrium the “implementing advocates” within the Remote Electronic Notarization are identified along with their strategies and benefits which will comprise the effect of the Nash Equilibrium.

U.S. Pat. No. 5,712,914 Aucsmith et al. sites the use of digital certificates with multimedia extensions where the art provides for a medium to electronically encrypted form for transporting and manipulating data, images, and video, this art does not specifically identify the use of this manner for remote electronic notarization via kiosk or telecommunication device i.e. cellular or PDA.

U.S. Pat. No. 6,317,777 Skarbo et al. sites the collaboration of parties via video teleconferencing via computer mediums. However this art like Aucsmith neglects the manipulation of electronic documents and video capacity of cellular devices and the like.

U.S. Pat. No. 6,496,851 Morris et al. discloses the management of communications between users in a computer network. However this particular art is limited again by its failure to recognize other mediums that incorporate computer communications i.e. cellular devices or the like. In addition this art as is required by proposed art neglects video implementation via computers or telecommunications devices i.e. cellular, PDA.

U.S. Publication No. 2001/0002485 and U.S. Pat. No. 7,162,635 Bisbee et al. discloses an invention relating to systems and methods for providing a verifiable chain of evidence and security for the transfer and retrieval of documents and other information objects in digital formats. However Bisbee sites, “The traditional legally accepted methods of verifying the identity of a document's originator, such as physical presence or appearance, a blue-ink signature, personal witness or Notary Public acknowledgment, are not possible.” This was short sighted and distances the arts' approach from the proposed art of remote electronic notarization.

U.S. Publication No. 2002/0156850 Hamscher et al. though abandoned, cited the negotiation of commercial transaction, e.g., the purchase and sale of an item of capital equipment using a communication network, e.g., the Internet. Using a standard web browser, e.g., Internet Explorer, buyers and sellers can connect to a website (operated by a website server) via the Internet. The website server has application software programmed to implement the negotiating functions that will be described below. If services that are ancillary to the purchase and sale become necessary in order to implement the transaction, these services (e.g., shipping, engineering, financing or legal services) can be accessed either through links provided on the website, or directly through the website. The buyer and seller can also contact consultants of their own (for example, their legal counsel) directly, either online or using conventional means such as mail or fax. Again though abandoned, this particular art, for the purposes of remote notarization does not allow for the screening and verification of signatories nor does it provide for a medium of communications via cellular devices. In addition for the uniqueness of the proposed art, the necessity to verify and authenticate is paramount to its function. This particular art fails to provide for this most crucial function as it pertains to remote electronic notarization. New inventions for paying on-line transactions are evolved and have eased the process.

U.S. Pat. No. 5,195,133 Kapp et al. cites an invention relating to a system and a method for processing signature-based payment transactions and more particularly relates to such a system and method in which a merchant's records of payment may be generated and maintained electronically without generation or use of paper records except those delivered to customers at the point of sale. This art relevance is to the administration of electronic merchant records and the generation of them, however, the art is short sighted as it pertains to the interfacing of this process within the scope of remote cellular/PDA and network functions interfacing with third party payment options as identified within the framework of the proposed art.

U.S. Pat. No. 4,731,840 Mniszewski et al. provides a method for the encryption, transmission, and subsequent decryption of digital keying data. The method utilizes the Data Encryption Standard and is implemented by means of a pair of apparatus, each of which is selectable to operate as either a master unit or remote unit. Each unit contains a set of key encryption keys which are indexed by a common indexing system. The master unit operates upon command from the remote unit to generate a data encryption key and encrypt the data encryption key using a pre-selected key encryption key. The encrypted data encryption key and an index designator are then downloaded to the remote unit, where the data encryption key is decrypted for subsequent use in the encryption and transmission data. Downloading of the encrypted data encryption key enables frequent change of keys without requiring manual entry or storage of keys at the remote unit. This art relevance is to the administration of electronic merchant records and the generation of them, however, the art is short sighted as it pertains to the interfacing of this process within the scope of remote cellular/PDA and network functions interfacing with third party payment options as identified within the framework of the proposed art.

It can be appreciated that methods of video conferencing have been in use for years. Typically, there exists a range of video conference systems or video communication systems that utilize a variety of structures, such as telephone, personal computers and mounted cameras to relay live stream video, and a variety of methods to facilitate the live stream conference. The prior art discloses U.S. Pat. No. 5,991,276 issued to Yamamoto; U.S. Pat. No. 6,124,882 issued to Voois et al; U.S. Pat. No. 6,121,998 issued to Voois et al; U.S. Pat. No. 6,128,033 issued to Friedel et al; and U.S. Pat. No. 6,037,970 issued to Kondo.

The Yamamoto patent depicts a multipoint videoconference system which delivers video and voice information along with various types of material data to realize a more realistic teleconferencing environment. The system comprises a plurality of videoconference terminals, a videoconference server, and a videoconference administration server. The videoconference administration server controls network connections between the videoconference server and the videoconference terminals. The Yamamoto patent does not depict a method and system of identity and signature and document authentication via a “real time” live stream video conference format.

The Vois U.S. Pat. No. 6,124,882 depicts a videophone device that utilizes a programmable processor circuit capable of communicating over a conventional communications channel, such as a POTS line, and of generating video data for display on a television set. The device includes a video source, an interface circuit, including a modem transmitting and receiving video and audio data over the channel; a circuit for storing a program to control the videophone apparatus; and a display driver circuit for generating video data to the display. The Vois U.S. Pat. No. 6,124,882 does not depict a method and system of identity and signature and document authentication via a “real time” live stream video conference format.

The Vois U.S. Pat. No. 6,121,998 depicts a programmable video/general-purpose processor capable of readily updating program-related data. The processor includes a first circuit section used to process data for videoconferencing and to detect codes data used for revising software-relate data provided from a remote location, and a second circuit section used for executing the executable program data stored in the second memory circuit. A volatile memory circuit is coupled to and accessed by the programmable video/general-purpose processor, and is used for storing the revision data until it is validated. The non-volatile memory circuit is then used by the processor in a subsequent video-related application, such as a videoconferencing application or a web browser application. The Vois patent does not depict a method and system of identity and signature and document authentication via a “real time” live stream video conference format.

The Friedel patent depicts an audiovisual communications terminal apparatus that is adapted for interconnection to at least one other audiovisual communications terminal apparatus by a communications medium to form an audiovisual teleconferencing network. The audiovisual communications terminal apparatus includes an interface device, producing and transmitting means, and receiving and broadcasting means. The interface device operates to condition input audiovisual signals received from the other audiovisual communications terminal apparatus and to condition output audiovisual signals for processing by the other audiovisual communication terminal apparatus. The receiving a broadcasting means receive the input audiovisual signals from the interface device and broadcast the received input audiovisual signals thereby creating an audiovisual teleconference between two users so that the users can both see and hear each other. The Friedel patent does not depict a method and system of identity and signature document authentication via a “real time” video conference format.

The Kondo patent depicts a videoconference system that conducts a videoconference among a plurality of communication centers which are connected by a communication line. Each communication center includes: display devices for displaying images from the other communication centers participating in the videoconference; speaker devices for outputting voices from the other communication centers participating in the videoconference; camera devices disposed at positions corresponding to the display devices, for imaging participants in the videoconference; microphone devices disposed at positions corresponding to the display devices, for capturing voices from the participants; and a transmitter/receiver transmitting output signals from the camera devices and output signals from the microphone devices to the other communication centers, and receiving output signals from the camera devices and output signals from the microphone devices of the other communication centers, the transmitter/receiver for supplying the output signals from the camera devices and the output signals from the microphone devices of the other communication centers to the display devices and the speaker devices corresponding to the camera devices and the microphone devices. The Kondo patent does not depict a method and system of identity and signature and document authentication via a “real time” live stream video conference format.

### BRIEF SUMMARY OF THE INVENTION

| | Strategy | Benefit |
|---|---|---|
| Notary | Provide Remote E-Notary services, | Participate in the Satellite |
| | increase availability, enhance roll as | Network Kiosk and have access to |
| | an officer of Sec. of State, increase | new Client(s) via online website |
| | income | application |
| | | Implement new technological |
| | Use new technology in all areas of | protocols for remote electronic |
| | notary | notarization, reduce travel |
| | | expense. |
| | Multi-lingual and E-Apostles | Offer multiple languages to help |
| | | foreign Client(s) in their notary |
| | | needs |
| | Assistance with identification | Participate in online remote |
| | verification to help Sec. of State and | notarizations via World Wide Web |
| | ensure the integrity of E-Commerce | |
| | Participate in new evolutions of E- | Usage of new E-Doc automation |
| | Documents via newly automated Gov | i.e. county recorders, interstate |
| | Auth. Systems | and international |
| Signatory | Receiving remote electronic notary | Ability to notarize via kiosk or |
| | service, enhance independence and | on-line virtual kiosk application; |
| | convenience; save time and money | increase internet trust, new |
| | | notary experience, access to |
| | | other services i.e. identity theft |
| | | solutions, drivers license renewal |
| | | etc . . . |
| | Identify theft protection tool in | Develop habit of notarizing |
| | cyberspace | important legal documentation |
| | | via remote electronic notarization |
| | Using Remote Notary Network for E- | Embedded/encrypted E- |
| | signature authentication | signatures authentication; forgery |
| | | prevention |
| | Using less paper to help protect | Tree preservation result in more |
| | environment | oxygen, more trees filter noise |
| | | pollution, paper reduction |
| Government | ID verification and automation for | Quicker response to public needs |
| Departments | E-documents | in legal activity |
| | Biometric tracking | Track criminals, pedophiles, and |
| | | terrorists |
| | Enhance trade foreign relation via | Remote E-Apostles |
| | E-Commerce of goods/shipping | Domestic and foreign trade policy |
| | | effective |
| | Increase employment via | Increased Trust from consumers |
| | increased goods ordered | for on-line shopping |
| | E.P.A. has another economic tool | Paper reduction |
| | to achieve its goal: protect the | |
| | environment | |
| E-Commerce | Increase integrity for cyberspace | Identity protection via Remote E- |
| | | Notary |
| | E-signature authentication | Embedded/encrypted signatures |
| | enhancement | via cryptographic protocols |
| | Increase goods orders | Jobs increased to fill |
| | national/international/shipping | manufacturers' orders |
| | Convenience of business | Remote Electronic Notaries |
| | | available for legal E-commerce |
| | | activity. |

As the charts indicate, Nash Equilibrium can be achieved as all of the aforementioned “implementing advocates” realize their benefit in the Remote Electronic Notarization matrix. However, the hope of these examples will provide the stage for the following detailed description of the Remote Electronic Notarization system and logic. The intent of the aforementioned was not to highlight a mere mathematicians' logic, however, the basis of this art rest in its illustration of logic proper. The main point of this example, underscore the idea of software that is linear in its nature primarily developed to perform the task of incorporating several electronic system operations predicated on a procedure that at its nexus implements a steganographic cryptographic protocol unique to a particular electronic transaction, namely Remote Electronic Notarization, however not limited to the same for example the system accommodates Drivers License Renewal, Passport Applications, Social Security Card Application, Green Card Application, Real I.D., Credit Card Application etc. It is also contemplated that the system will provide for an on-line survey via both, Satellite network kiosk or on-line virtual kiosk application displaying in real-time via LED color coded indicator, categories of service efficiency i.e. professionalism, communication between notary/system and signatory/client, timeliness, etc. In addition for notarizations, it is contemplated to provide via system network, notary availability via LED color coded indicator, from 0 to 100 showing system activity for signatory to determine timeliness of remote electronic notary system response.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a flow diagram of a network server and the connections to the server.

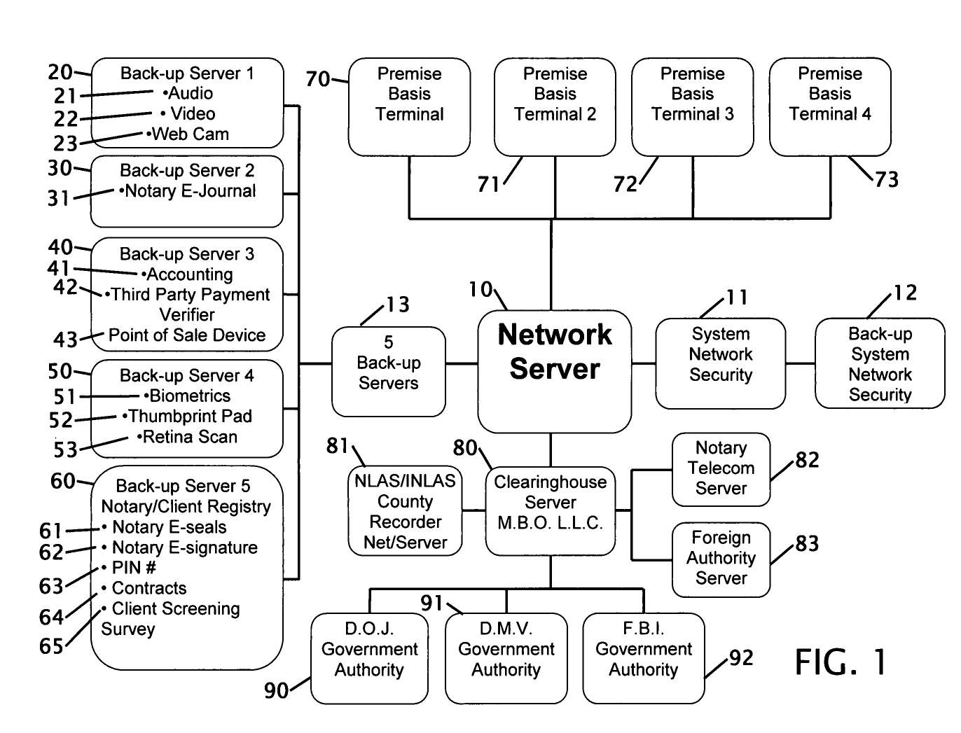

### DETAILED DESCRIPTION

Client(s) Registration

Satellite network kiosk or on-line virtual kiosk application via interface/interlink Public Key Infrastructure (PKI) via interface/interlinked Virtual Private Network (VPN) interface/interlinked Electronic Network Server Authority 10 (ENSA) via touch screen technology/keyboard deploying log on template from Premise Based terminals 70 , 71, 72 and 73. Satellite network kiosk or on-line virtual kiosk application via interface/interlink Public Key Infrastructure (PKI) interface/interlinked Virtual Private Network (VPN) interface/interlinked Electronic Network Server Authority 10 (ENSA) interface/interlink Clearing House Server 80 (CHS), Notary/Client(s) Registry Server 60 (NCRSBU5), Language Repository Server (LRS7) accessing and prompting Language Repository (LR) selection template. Language Repository Server (LRS7) interface Sight/Hearing Impaired Disability Server (SHIDS6) prompting Audio Tab template for Sight Impaired, Video Sign Hand Language Tab template for Hearing Impaired, or Voice Actuation Tab. Signatory selects required languages, interfacing system network operation to configure transaction to selected format. Language Repository (LRS7) system will integrate tenets of the American Disabilities Act (ADA) for language compliance. The Electronic Network Server Authority 10 (ENSA) has one or more System Network Security 11 systems for protection of the data and a Back-up System Network Security 12 system to protect the data.

Satellite network kiosk or on-line virtual kiosk application via Public Key Infrastructure (PKI) via interface/interlinked Virtual Private Network (VPN) Electronic Network Server Authority 10 (ENSA), Clearing House Server 80 (CHS), interface/interlink prompting geographical location template interfacing\interlink via Public Key Infrastructure (PKI) interface/interlinked Virtual Private Network (VPN) connectivity of National Local Authority Server (NLAS) or International Local Authority Server (ILAS) 81.

Satellite network kiosk or on-line virtual kiosk application via Public Key Infrastructure (PKI) interface/interlinked Virtual Private Network (VPN) interface/interlink Electronic Network Server Authority 10 (ENSA) interface/interlink, Clearing House Server 80 (CHS), Notary/Client(s) Registry Server 60 (NCRSBU5) prompting Client(s) Contract 64 (CC) template. Client(s) Contract 64 (CC) template prompts to accept or decline. If Client(s) Contract 64 (CC) is declined, the transaction will terminate. If Client(s) Contract 64 (CC) is accepted electronic transaction record will continue. The authorization can also be completed using a Notary Telecom Server 82 or with a Foreign Authority Server 83.

Satellite network kiosk or on-line virtual kiosk application via Public Key Infrastructure (PKI) interface/interlinked Virtual Private Network (VPN) interface/interlink Electronic Network Server Authority 10 (ENSA) interface/interlinks the Clearing House Server 80 (CHS), Notary/Client(s) Registry Server 60 (NCRSBU5) prompting Personal Identification Number 63 (PIN) template for 63 (PIN) composition. Completion of (PIN) 63 composition is now electronically affixed to electronic transaction record as the Signatory's Personal Identification Number 63 (PIN) for future system verification of Signatory and future access to network. Both, Client(s) Contract 64 (CC) and Personal Identification Number 63 (PIN), will be archived via Electronic Network Server Authority 10 (ENSA) and Clearing House Server 80 (CHS) into the Notary/Client(s) Registry Server 60 (NCRSBU5).

Public Key Infrastructure (PKI) via interface/interlinked Virtual Private Network (VPN) interface/interlinked Electronic Network Server Authority 10 (ENSA), Clearing House Server 80 (CHS) will issue a digital certificate to the Signatory's electronic transaction record. Satellite network kiosk via Public Key Infrastructure (PKI) via interface/interlinked Virtual Private Network (VPN) interface/interlinked Electronic Network Server Authority 10 (ENSA), interface Electronic Biometric Retina Scan 53 (EBRS) template for optional Signatory authentication and verification of Signatory identification information logically linked to Signatory's Client(s) Contract 64 (CC) and Personal Identification Number 63 (PIN).

Satellite network kiosk via Public Key Infrastructure (PKI) via interface/interlinked Virtual Private Network (VPN) interface/interlinked Electronic Network Server Authority 10 (ENSA), Clearing House Server 80 (CHS) interfaces Electronic Biometric Retina Scan 53 (EBRS) template displaying options for Retina Scan, Electronic Biometric Retina Scan 53 (EBRS) device will deploy Electronic Biometric Retina Scan 53 (EBRS) capturing template instruction.

Satellite network kiosk via Public Key Infrastructure (PKI) via interface/interlinked Virtual Private Network (VPN) interface/interlinked Electronic Network Server Authority 10 (ENSA), Clearing House Server 80 (CHS) interfaces Electronic Biometric Retina Scan 53 device infra-red scanner affixed to Satellite network kiosk, captures the electronic retinal record of the Signatory. Signatory electronic retinal record will via Electronic Network Server Authority 10 (ENSA), Clearing House Server 80 (CHS), logically link to Signatory's Client(s) Contract 64 (CC) and Personal Identification Number 63 (PIN) and archive to the Biometric 51 Back-Up Server 50 4 (BBUS4). This completes the Signatory registration and required network system activations for both satellite network kiosk and on-line virtual kiosk application.

Satellite network kiosk via Public Key Infrastructure (PKI) interface/interlinked Virtual Private Network (VPN) interface/interlink Electronic Network Server Authority 10 (ENSA) interface/interlinks the Clearing House Server 80(CHS), Notary/Client(s) Registry Server 60 (NCRSBU5) interfaced/interlinked to a Radio Frequency Identification Digital system and (RFID) Reader. The reader is a fixed-mount device in the Satellite Kiosk or End-User device, emitting electromagnetic (radio) waves or the like. These waves or the like can range from one inch to 100 feet and is dependent on power output and the radio frequency used. The reader generates an electromagnetic field through its antenna. Once the RFID tag enters the detection area, it becomes active when receiving a signal through its own antenna. This signal is used to turn on the RFID tag's transmitter and allows the RFID tag to communicate and exchange information with the reader. The reader then transmits the data to Electronic Network Server Authority 10 (ENSA) interface/interlinks the Clearing House Server 80 (CHS), Notary/Client(s) Registry Server 60 (NCRSBU5) Radio Frequency Identification Digital system for processing and management. A small amount of radio frequency energy passes from the reader energizing the dormant RFID tag which then emits a radio frequency signal transmitting the individual's unique verification number. This individual's unique verification number is verified and authenticated by the Notary/Client(s) Registry Server 60 (NCRSBU5) corroborating information of the newly created 63 PIN. Future access to the Electronic Network Server Authority 10 (ENSA) Satellite Kiosk or End-User device can now occur via RFID detection and PIN entry.

Remote Electronic Notary Connectivity

Satellite network kiosk or on-line virtual kiosk application interface/interlink with Public Key Infrastructure (PKI) via Virtual Private Network (VPN) interface/interlinked Electronic Network Server Authority 10 (ENSA), Clearing House Server 80 (CHS), Notary/Client(s) Registry Server 60 (CRSBU5), TELCOM Server, Audio 21/Video 22 Back-Up Server 1 20 (AVBUS1) interface/interlink H.323 protocol compliant electronic audio/video software, prompts COM-link template for connectivity to Cellular/PDA Device or Portable PC Device. Other connection means are contemplated including but not limited to digital wireless, WIFI, satellite signal, radio communication, microwave dish, cable line, or phone line. Established COM-link will deploy Notary pre-registered cellular/PDA device or portable pc device, Web-Cam 23 with microphone on Satellite network kiosk. Established COM-link will interface on-line virtual kiosk application for end user system Web-Cam 23 with microphone deployment. Audio/video system provides “Picture in Picture” or “Split Screen” on both Cellular/PDA or Portable PC Device and satellite network kiosk or on-line virtual kiosk application interfacing both parties; Notary and Signatory, to real-time recorded video imagery and sound as well as provide the Notary a visual medium for the Signatory electronic document.

Satellite network kiosk or on-line virtual kiosk application interface/interlink with Public Key Infrastructure (PKI) via Virtual Private Network (VPN) interface/interlinked Electronic Network Server Authority 10 (ENSA), Clearing House Server 80 (CHS), TELCOM Server, Notary/Client(s) Registry Server 60 (NCRSBU5) interface/interlink to deploy a steganographic and cryptographic encrypted protocol of the notary pre-registered cellular/PDA device or portable pc device identification number, notary commission number, and electronic notary seal 61 data providing the, “Electronic DNA” for the particular Remote Electronic Notarization transaction. These three alphanumeric identifiers will electronically convert into a steganographic cryptographic protocol, steganographically embedded within the electronic font print lines of both the Notary and Signatory's electronic signature per implement. Steganographic cryptographic protocol system feature interfaces only if there exist a COM-link of Satellite network kiosk or on-line virtual kiosk application interface/interlink with Public Key Infrastructure (PKI) via Virtual Private Network (VPN) to the Electronic Network Server Authority 10 (ENSA), Clearing House Server 80 (CHS), TELCOM Server, and Notary/Client(s) Registry Server 60 (NCRSBU5).

Cellular/PDA or Portable PC Device interface/interlink with Public Key Infrastructure (PKI) via Virtual Private Network (VPN) interface/interlink Electronic Network Server Authority 10 (ENSA), Clearing House Server 80 (CHS), TELCOM Server, and Notary/Client(s) Registry Server 60 (NCRSBU5) interface/interlink to access the Signatory Assessment Screening Survey 65 (SASS). Satellite network kiosk or on-line virtual kiosk application interface/interlink with Public Key Infrastructure (PKI) via Virtual Private Network (VPN) interface/interlink Electronic Network Server Authority 10 (ENSA), Clearing House Server 80 (CHS), TELCOM Server, and Notary/Client(s) Registry Server 60 (NCRSBU5) interface/interlink to Signatory Assessment Screening Survey 65 (SASS) template prompts Signatory required data entry and electronic signature 62 of Signatory via electronic signature 62 capture device or key board into Signatory Assessment Screening Survey 65 (SASS). Electronic Network Server Authority 10 (ENSA), Clearing House Server 80 (CHS), electronically records both audio/video real-time data streams of Signatory Assessment Screening Survey 65 (SASS) archived to Notary/Client(s) Registry Server 60 (NCRSBU5).

Electronic Journal 31

Satellite network kiosk or on-line virtual kiosk application interface/interlink with Public Key Infrastructure (PKI) via Virtual Private Network (VPN) interface/interlink Dept of Justice/Government Authority (DOJ/GA Server) 90, Federal Bureau Of Investigation/Government Authority (FBI/GA Server) 92, Dept Of Motor Vehicles/Government Authority (DMV/GA) 91, Electronic Network Server Authority 10 (ENSA), Clearing House Server 80 (CHS), TELCOM Server, Audio 21/Video 22 Back-Up Server 1 20 (AVBUS1), Electronic Journal 31 Back-Up Server 30 2 (EJBUS2) prompts, via “Picture In Picture” or “Split Screen” on monitor screen of both the Cellular/PDA or Portable PC Device interface/interlink deploying Electronic Journal 31 template displaying vacant fields beacon alerts via monitor screen of both the Cellular/PDA or Portable PC Device and satellite network kiosk apparatus or on-line virtual kiosk application, Web Cam 23 with microphone connectivity, Electronic Signature 62 capturing device, Electronic Thumb-print Pad 52 COM-linked to notary Cellular/PDA or Portable PC Device via notary pre-registered Cellular/PDA or Portable PC identification. Electronic beacon alerts highlights vacant Electronic Journal 31 template fields prompting Signatory execution data entry via Electronic Signature 62 Capturing Device or keyboard synchronizing and deploying steganographic and cryptographic encrypted protocol of the notary registered cellular/PDA device or portable pc device identification number, notary commission data, steganographically embedded within the electronic font print lines of the Signatory's electronic signature per implement. Electronic Thumb-print Pad 52 Capturing Device template will display (for Satellite Kiosk Only) prompting Signatory execution of implementation of Electronic Thumb-print Pad 52, systematically appended to Signatory Personal Identification Number 63 (PIN), interfacing and synchronizing real-time verification to Cellular/PDA or Portable PC Device via Dept of Justice/Government Authority (DOJ/GA Server) and Federal Bureau Of Investigation/Government Authority (FBI/GA Server) or the like however not limited to the same.

Satellite network kiosk or on-line virtual kiosk application interface/interlink with Public Key Infrastructure (PKI) via Virtual Private Network (VPN) interface/interlink, Electronic Network Server Authority 10 (ENSA), Clearing House Server 80 (CHS), TELCOM Server, Notary/Client(s) Registry Server 60 (NCRSBU5), Electronic Journal 31 Back-Up Server 30 2 (EJBUS2), Audio 21/Video 22 Back-Up Server 1 20 (AVBUS1) interface/interlink Electronic Web Cam 23 with microphone template for execution of still Electronic Photo of Signatory systematically appended to Signatory Personal Identification Number 63 (PIN).

Satellite network kiosk or on-line virtual kiosk application interface/interlink with Public Key Infrastructure (PKI) via Virtual Private Network (VPN) interface/interlink, Electronic Network Server Authority 10 (ENSA), Clearing House Server 80 (CHS), TELCOM Server, Notary/Client(s) Registry Server 60 (NCRSBU5), Dept Of Motor Vehicles/Government Authority (DMV/GA) 91, ElectronicJournal 31 Back-Up Server 30 2 (EJBUS2) deploying Signatory identification template beacon alerts highlights vacant fields, prompting data entry execution via Satellite Kiosk Point of Sale Device 43 or on-line virtual kiosk application end user data entry device interfacing real-time Dept Of Motor Vehicles/Government Authority (DMV/GA) validation of Signatory identification interfacing via Electronic Network Server Authority 10 (ENSA), Clearing House Server 80 (CHS), TELCOM Server, Notary/Client(s) Registry Server 60 (NCRSBU5), system archiving of data. If Signatory identification is not validated by Dept of Motor Vehicles/Government Authority (DMV/GA) prompts for other electronically verifiable Signatory identification will be requested. Signatory non-compliance interfaces Electronic Network Server Authority 10 (ENSA) to terminate remote electronic notary transaction.

Electronic Document Retrieval and Disposition

Satellite network kiosk or on-line virtual kiosk application interface/interlink with Public Key Infrastructure (PKI) via Virtual Private Network (VPN) interface/interlink Electronic Network Server Authority 10 (ENSA), Clearing House Server 80 (CHS), TELCOM Server, Audio 21/Video 22 Back-Up Server 1 20 (AVBUS1) COM-link via Cellular/PDA or Portable PC Device, prompts, via “Picture In Picture” or “Split Screen” on monitor screen of both the Cellular/PDA or Portable PC Device interface/interlink Network Document Repository (NDR) interfacing both National Local Authority Server (NLAS) or International Local Authority Server (ILAS) for electronic document selection, deploying satellite network kiosk electronic scanning device or (create up-link via on-line virtual kiosk application from end user electronic scanning device), or interface/interlink electronic retrieval of electronic document via electronic records delivery systems. Electronic document template displays via “Picture in Picture” or “Split Screen” on monitor screen of both the Satellite network kiosk or on-line virtual kiosk application and Cellular/PDA or Portable PC Device. Electronic beacon alerts highlights vacant Electronic Document template fields prompting Signatory execution of the same synchronizing and deploying steganographic and cryptographic encrypted protocol of the notary pre-registered cellular/PDA device or portable pc device identification number, notary commission data, steganographically embedded within the electronic font print lines of the Signatory's electronic signature per implement. Signatory execution interfaces network archiving of required information.

Satellite network kiosk or on-line virtual kiosk application interface/interlink with Public Key Infrastructure (PKI) via Virtual Private Network (VPN) interface/interlink Electronic Network Server Authority 10 (ENSA), Clearing House Server 80 (CHS), TELCOM Server, Audio 21/Video 22 Back-Up Server 1 20 (AVBUS1) COM-link via Cellular/PDA or Portable PC Device prompts transmitting template of electronic documents via electronic records delivery system COM-linked to digitally wire-less broadband cellular/PDA device or portable pc device deploying an interactive mode/end user block for electronic document with cellular/PDA device or portable pc device for electronic document data entry of Notary Electronic Seal 61 and Notary Electronic Signature, 62 via notary cellular/PDA device or portable pc device.

Client Payement/Third Party Payment Verifier 42 Connectivity

Satellite network kiosk or on-line virtual kiosk application interface/interlink with Public Key Infrastructure (PKI) via Virtual Private Network (VPN) interface/interlink Electronic Network Server Authority 10 (ENSA), Clearing House Server 80 (CHS), Accounting 41 Back-Up Server 40 3 (ABUS3), prompts payment template requesting CAPTCHA entry and data entry of Signatory payment information interface/interlink for Signatory payment processing via third party payment verifier 42 electronically signaling via Electronic Network Server Authority 10 (ENSA), Clearing House Server 80 (CHS), TELCOM Server, Satellite network kiosk or on-line virtual kiosk application interface/interlinked COM-linked to digitally wire-less broadband Cellular/PDA device or portable pc device, approval or denial of Signatory payment. If Signatory payment is denied, Accounting 41 Back-Up Server 40 3 (ABUS3) will prompt alternative payment options. If Signatory payment alternatives are denied via third party payment 42 verifier, Electronic Network Server Authority 10 (ENSA) terminates Remote Electronic Notary Transaction.

Third party payment verifier 42 electronic approval of the aforementioned, prompts Cellular/PDA device or portable pc device via interface/interlinked Electronic Network Server Authority 10 (ENSA), Clearing House Server 80 (CHS), TELCOM Server, Accounting 41 Back-Up Server 40 3 (ABUS3), archive Signatory payment to Accounting 41 Back-Up Server 40 3 (ABUS3). Cellular/PDA device or portable pc device interface/interlinked TELCOM Server, Clearing House Server 80 (CHS), Electronic Network Server Authority 10 (ENSA) interface/interlink Virtual Private Network (VPN) via Public Key Infrastructure (PKI) interface/interlink to on-line virtual kiosk application or Satellite network kiosk via electronic records delivery system transmits notarized electronic document displaying notarized electronic document via monitor screen.

Additionally, Satellite network kiosk or on-line virtual kiosk application interface/interlink with Public Key Infrastructure (PKI) via Virtual Private Network (VPN) interface/interlink via Electronic Network Server Authority 10 (ENSA), Clearing House Server 80 (CHS) notarized electronic document designated (i.e. deeds, title documents etc.) for National Local Authority Server (NLAS) or International Local Authority Server (ILAS) will receive notarized electronic document via electronic records delivery system transmission per Uniform Real Property Electronic Recording Act (URPERA) electronic protocols.

Client Retrieval and Final Disposition of notarized Electronic Document

Cellular/PDA device or portable pc device interface/interlinked TELCOM Server, Clearing House Server 80 (CHS), Electronic Network Server Authority 10 (ENSA) interface/interlink Virtual Private Network (VPN) via Public Key Infrastructure (PKI) interface/interlink to on-line virtual kiosk application or Satellite network kiosk via electronic records delivery system transmits notarized electronic document displaying notarized electronic document via monitor screen, prompting final electronic document disposition template displaying, via monitor screen, three tab options.

Final electronic document disposition template display will alert system to interface/interlink tab (1) to third party archive server via secured Public Key Infrastructure (PKI) interface/interlinked Virtual Private Network (VPN) ) interface/interlink network connectivity of National Local Authority Server (NLAS) or International Local Authority Server (ILAS) optioning, via monitor screen, transmission/archiving instructions for electronic document disposition prompting third party archive system interface optioning transmission/archiving instructions for electronic document disposition.

Final electronic document disposition template display will alert system to interface/interlink tab (2) Satellite network kiosk or on-line virtual kiosk application interface/interlink with Public Key Infrastructure (PKI) via Virtual Private Network (VPN) interface/interlink via Electronic Network Server Authority 10 (ENSA), Clearing House Server 80 (CHS) interface/interlinked internet electronic records delivery system transmission for post retrieval.

Final electronic document disposition template display will alert system to interface/interlink tab (3) Satellite network kiosk or on-line virtual kiosk application interface/interlink with Public Key Infrastructure (PKI) via Virtual Private Network (VPN) interface/interlink via Electronic Network Server Authority 10 (ENSA), Clearing House Server 80 (CHS) interface/interlink deployment of electronic printer device of Satellite network kiosk (for on-line virtual kiosk application, printer tab option for end user printing device deployment). Electronic Network Server Authority 10 (ENSA), Clearing House Server 80 (CHS), compiles all electronic records germane to particular transaction archiving all pertinent backup servers 13. Electronic Network Server Authority 10 (ENSA) terminates Remote Electronic Notary Network System via sign-off template optioning printing of the transaction information/receipt or via electronic records delivery system, transmits information/receipt germane to the transaction to a remote computer.

Satellite network kiosk via Public Key Infrastructure (PKI) interface/interlinked Virtual Private Network (VPN) interface/interlink Electronic Network Server Authority 10 (ENSA) interface/interlinks the Clearing House Server 80 (CHS), Notary/Client(s) Registry Server 60 (NCRSBU5) interfaced/interlinked to a Radio Frequency Identification (RFID) Reader. The reader is a fixed-mount device in the Satellite Kiosk or End-User device, emitting electromagnetic (radio) waves or the like. These waves or the like can range from one inch to 100 feet and is dependent on power output and the radio frequency used. The reader generates an electromagnetic field through its antenna. Once the RFID tag enters the detection area, it becomes active when receiving a signal through its own antenna. This signal is used to turn on the RFID tag's transmitter and allows the RFID tag to communicate and exchange information with the reader. The reader then transmits the data to Electronic Network Server Authority 10 (ENSA) interface/interlinks the Clearing House Server 80 (CHS), Notary/Client(s) Registry Server 60 (NCRSBU5) for processing and management. A small amount of radio frequency energy passes from the reader energizing the dormant RFID tag which then emits a radio frequency signal transmitting the individual's unique verification number. This individual's unique verification number is verified and authenticated by the Notary/Client(s) Registry Server 60 (NCRSBU5) corroborating information of the newly created PIN 63. Future access to the Electronic Network Server Authority 10 (ENSA) Satellite Kiosk or End-User devices can now occur via RFID detection and PIN 63 entry.

Thus, specific embodiments of a System for Remote Electronic Notarization and Signatory Verification and Authentication/Interface/interlinked with an Advanced Steganographic Cryptographic Protocol have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A steganographic, cryptographic protocol for notary services comprising:
a data input device;
a network server;
a notary;
registering said data input device with a steganographic encryption algorithm;
establishing a communications link with at least one user between said registered input device, said network server and a notary wherein a digitized notary identification is embedded within font signature lines of said communications link;
establishing a first interface with said user with said network server to create a unique cryptographic identify for said at least one user on said network server;
establishing a second or subsequent interface with said network server that compares said first and prior cryptographic identification with said second or subsequent interface to verifying said unique cryptographic identify of said user on said network server to authenticate said user to perform notary service(s) using a steganographic data encryption algorithm.

2. The steganographic, cryptographic protocol according to claim 1 wherein said data input device is a terminal with a point of sale device is a magnetic card reader or data card reader.

3. The steganographic, cryptographic protocol according to claim 1 wherein said data input device is a terminal with a biometric authorization parameter is a fingerprint reader, a retinal scanner, a facial recognition, a voice recognition device or a signature entry device.

4. The steganographic, cryptographic protocol according to claim 1 wherein said data input device is a terminal with manual user input capability of a keyboard, mouse, scanner, touch screen, signature pad, microphone, video, audio, camera, or trackball.

5. The steganographic, cryptographic protocol according to claim 1 wherein said data input device is a cellular PDA, computer or phone via a live streaming video audio, communications and recording.

6. The steganographic, cryptographic protocol according to claim 1 wherein said unique cryptographic identity is with said user's signature.

7. The steganographic, cryptographic protocol according to claim 1 wherein said network server includes at least one back-up server

8. The steganographic, cryptographic protocol according to claim 1 wherein said network server includes a network security software.

9. The steganographic, cryptographic protocol according to claim 1 wherein said cryptographic identity is determined with a driver's license, bank card, photo identification, credit card, RFID chip, or military identification.

10. The steganographic, cryptographic protocol according to claim 1 wherein said communication link is by means of internet, cellular phone, radio communication, microwave dish, cable line, or phone line.

11. The steganographic, cryptographic protocol according to claim 1 wherein said notary service authorizes notarized documents where more than one signatory is involved.

12. The steganographic, cryptographic protocol according to claim 1 wherein said notary service is for a loan, mortgage, deed, affidavit, jurat, E-apostilles, legal documents, trust, wills, assignment, voting or authorization.

13. The steganographic, cryptographic protocol according to claim 1 that further includes archival capabilities for said notary service(s).

14. The steganographic, cryptographic protocol according to claim 1 that further includes capability to forward notarized document to a third party.

15. The steganographic, cryptographic protocol according to claim 1 wherein said communications link is provided over a secure data link.

16. The steganographic, cryptographic protocol according to claim 1 that further includes a receipt printer for printing a receipt for monetary payment of a transaction and a printer for printing a finalized document.

17. The steganographic, cryptographic protocol according to claim 1 wherein a notary journal is generated from said first and subsequent interface and said notary journal includes a sortable database to sort for signers, documents, and dates.

18. The steganographic, cryptographic protocol according to claim 1 wherein said data input device further includes an ability to affix a notary seal to notarized document.

19. The steganographic, cryptographic protocol according to claim 1 wherein said data input device includes an interface for a RFID device to verify and authenticate said user.

20. The steganographic, cryptographic protocol according to claim 1 that includes a clearing house server that communicates to government authorities.
